(19) United States
(12) Patent Application Publication
(10) Pub. No.: US 2009/0103242 A1
(43) Pub. Date: Apr. 23, 2009

(54) Electrode with Reduced Resistance Grid and Hybrid Energy Storage Device Having Same

(75) Inventors: Edward R. Buiel, New Castle, PA (US); Joseph E. Cole, New Castle, PA (US)

Correspondence Address: CAHN & SAMUELS LLP, 1100 17th STREET NW, SUITE 401, WASHINGTON, DC, 20036, US

(73) Assignee: AXION POWER INTERNATIONAL, INC., New Castle, PA (US)

(21) Appl. No.: 12/241,736

(22) Filed: Sep. 30, 2008

Related U.S. Application Data
(63) Continuation-in-part of application No. 11/875,119, filed on Oct. 19, 2007.

(51) Int. Cl. H01G 9/155; H01M 4/02

(52) U.S. Cl. 361/502; 429/211

(57) ABSTRACT

An energy storage device includes at least one positive electrode comprising a current collector comprising lead and having a plurality of raised and lowered portions with respect to a mean plane of the current collector and slots formed between the raised and lowered portions, wherein lead dioxide paste is adhered to and in electrical contact with the surfaces thereof; and a tab portion; and at least one negative electrode comprising a carbon material.

### I. RELATED APPLICATIONS

This application is a continuation-in-part application of U.S. Ser. No. 11/875,119 filed on Oct. 19, 2007 and claims priority of both U.S. Ser. No. 60/853,438 filed on Oct. 23, 2006, the entirety of which is incorporated by reference herein, and U.S. Ser. No. 60/891,151 filed on Feb. 22, 2007, the entirety of which is incorporated by reference herein.

### II. FIELD OF THE INVENTION

This invention relates to an electrode having a reduced resistance grid and to a hybrid energy storage device comprising at least one such electrode.

### III. BACKGROUND OF THE INVENTION

Hybrid energy storage devices, also known as asymmetric supercapacitors or hybrid battery/supercapacitors, combine battery electrodes and supercapacitor electrodes to produce devices having a unique set of characteristics including cycle life, power density, energy capacity, fast recharge capability, and a wide range of temperature operability. Hybrid lead-carbon energy storage devices employ lead-acid battery positive electrodes and supercapacitor negative electrodes. See, for example, U.S. Pat. Nos. 6,466,429; 6,628,504; 6,706,079; 7,006,346; and 7,110,242.

The positive electrode of a hybrid energy storage device effectively defines the active life of the device. Just as with lead-acid batteries, the lead-based positive electrode typically fails before the negative electrode. Such failures are generally the result of the loss of active lead dioxide paste shedding from the current collector grid as a consequence of spalling and dimensional change deterioration that the active material undergoes during charging and discharging cycles.

The conventional wisdom is that such energy storage devices, particularly those made in commercial quantities require significant compression of the electrodes as they are placed into the case for the energy storage device. Moreover, because supercapacitor energy storage devices of the sort discussed herein comprise lead-based positive electrodes together with carbon-based negative electrodes, and lead-based positive electrodes are known from the lead acid battery art, considerable attention has been paid to the development of improved negative electrodes. Indeed, improved negative electrodes, current collectors therefor, and the assembly of improved supercapacitor energy storage devices, are described in several co-pending applications which are commonly owned by Axion Power International Inc.

However, what has been overlooked to a greater or lesser extent is the fact that it is the positive electrode of supercapacitor energy storage devices which effectively defines the active life of the device. It happens that the negative electrodes typically will not wear out; but on the other hand, just as with lead acid storage batteries, the positive lead-based electrodes of supercapacitor energy storage devices will typically fail first. Those failures are generally the result of the loss of active lead dioxide paste shedding from the current collector grid as a consequence of spalling and dimensional change deterioration which the active material undergoes during charging and discharging cycles.

The inventors herein have unexpectedly discovered that if the positive electrodes are constructed so as to have undulating surfaces, then there is less likelihood of failure of those positive electrodes, and therefore there is less likelihood of failure of the supercapacitor energy storage devices as discussed herein.

U.S. Pat. No. 5,264,306 describes a lead acid battery system having a plurality of positive grids and a plurality of negative grids with respect of chemical pastes placed therein, where each of the grids has a mean plane and a matrix of raised and lowered portions formed in vertically oriented rows which alternate with undisturbed portions that provide unobstructed current channels extending from the lower areas of the grid plate to the upper areas of the grid plate with a conductive tab affixed thereto.

U.S. Design Pat. Des. 332,082 shows a battery plate grid of the sort which is described and used in lead-acid batteries as taught in U.S. Pat. No. 5,264,306. Both U.S. Pat. No. 5,264,306 and U.S. Design Pat. Des. 332,082 are incorporated herein by reference in their entireties.

### IV. SUMMARY OF THE INVENTION

In accordance with one aspect of the present invention, there is provided a hybrid lead-carbon-acid supercapacitor energy storage device having at least one cell, wherein said at least one cell comprises a plurality of lead-based positive electrodes and a plurality of carbon-based negative electrodes, with separators therebetween, an acid electrolyte, and a casing therefor.

Each carbon-based negative electrode comprises a highly conductive current collector, porous carbon material adhered to and in electrical contact with at least one surface of said current collector, and a tab element extending above the top edge of said negative electrode.

Each lead-based positive electrode has a lead-based current collector and a lead dioxide-based paste adhered to and in electrical contact with the surfaces thereof, and a tab element extending above the top edge of said positive electrode.

The front and back surfaces of said lead-based current collector each have a matrix of raised and lowered portions with respect to a mean plane for said lead-based current collector, and slots formed between the raised and lowered portions.

Thus, the aggregate thickness of said lead-based current collector is greater than the thickness of the lead-based material forming said current collector.

The hybrid energy storage device of the present will typically comprise a plurality of cells, which are inserted one each into a plurality of compartments formed in said casing.

It is an object of the present invention to provide an electrode that minimizes spalling or flaking of the active material during charge and discharge cycles.

It is yet another object of the present invention to reduce or minimize boundary conditions in the direction of current flow from lower portions to upper portions of the grid plate and to the associated collector tab structure of an electrode.

It is an object of the present invention to provide a hybrid energy storage device having improved cycle life.

It is an advantage of the present invention that there is reduced likelihood of failure of a positive electrode and a hybrid energy storage device containing such a positive electrode.

In accordance with one aspect of the present invention, an electrode is provided comprising a current collector comprising a grid, the grid comprising a plurality of planar, parallel rows disposed between interleaved rows having raised and lowered segments, and a tab portion extending from a side of the current collector. The rows of raised and lowered segments extend in a horizontal configuration relative to the tab portion, thereby providing substantially uninterrupted conductive ribbons extending from the bottom of the current collector to the tab portion.

As used herein “substantially”, “generally”, “relatively”, “approximately”, and “about” are relative modifiers intended to indicate permissible variation from the characteristic so modified. It is not intended to be limited to the absolute value or characteristic which it modifies but rather approaching or approximating such a physical or functional characteristic.

References to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

In the following description, reference is made to the accompanying drawings, which are shown by way of illustration to specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### V. BRIEF DESCRIPTION OF THE DRAWINGS

FIG. 1 illustrates a prior art grid plate.

FIG. 2 is an elevation magnified sectional view of FIG. 1.

FIG. 3 is a schematic representation of FIG. 1 and of a current flow path through that grid plate.

FIG. 4 illustrates a grid plate according to the present invention and a current flow path.

FIG. 5A illustrates a grid plate having vertical angled slots.

FIG. 5B is a cross sectional view of the grid plate of FIG. 5A along an A-A axis.

FIG. 5C is a magnified view of detail B of FIG. 5B.

FIG. 5D is a cross sectional view of the grid plate of FIG. 5A along a D-D axis.

FIG. 5E is a magnified view of detail D of FIG. 5D.

FIG. 5F is a perspective view of the grid plate of FIG. 5A.

FIG. 6A illustrates a grid plate according to the present invention having horizontal angled slots.

FIG. 6B is a cross sectional view of the grid plate of FIG. 5A along an A-A axis.

FIG. 6C is a magnified view of detail C of FIG. 5B.

FIG. 6D is a cross sectional view of the grid plate of FIG. 6A along a B-B axis.

FIG. 6E is a magnified view of detail D of FIG. 6D.

FIG. 6F is a perspective view of the grid plate of FIG. 6A.

FIG. 7A illustrates a grid plate having vertical square slots.

FIG. 7B is a cross sectional view of the grid plate of FIG. 7A along an A-A axis.

FIG. 7C is a magnified view of detail C of FIG. 7B.

FIG. 7D is a cross sectional view of the grid plate of FIG. 7A along a B-B axis.

FIG. 7E is a magnified view of detail D of FIG. 7D.

FIG. 7F is a perspective view of the grid plate of FIG. 7A.

FIG. 8A illustrates a grid plate according to the present invention having horizontal square slots.

FIG. 8B is a cross sectional view of the grid plate of FIG. 8A along an A-A axis.

FIG. 8C is a magnified view of detail C of FIG. 8B.

FIG. 8D is a cross sectional view of the grid plate of FIG. 8A along a B-B axis.

FIG. 8E is a magnified view of detail D of FIG. 8D.

FIG. 8F is a perspective view of the grid plate of FIG. 8A.

FIG. 9A illustrates a grid plate having vertical rounded slots.

FIG. 9B is a cross sectional view of the grid plate of FIG. 9A along an A-A axis.

FIG. 9C is a magnified view of detail C of FIG. 9B.

FIG. 9D is a cross sectional view of the grid plate of FIG. 9A along a B-B axis.

FIG. 9E is a magnified view of detail D of FIG. 5D.

FIG. 9F is a perspective view of the grid plate of FIG. 9A.

FIG. 10A illustrates a grid plate according to the present invention having horizontal rounded slots.

FIG. 10B is a cross sectional view of the grid plate of FIG. 10A along an A-A axis.

FIG. 10C is a magnified view of detail C of FIG. 10B.

FIG. 10D is a cross sectional view of the grid plate of FIG. 10A along a B-B axis.

FIG. 10E is a magnified view of detail D of FIG. 10D.

FIG. 10F is a perspective view of the grid plate of FIG. 10A.

FIG. 11 illustrates a schematic representation of a hybrid energy storage device according to the present invention.

FIG. 12 is a perspective view of an assembled cell in keeping with the present invention.

FIG. 13 is an elevation view of a typical current collector utilized in the positive electrodes of the cell shown in FIG. 12.

FIG. 14 is a cross-section in the direction of arrows A-A in FIG. 13.

### VI. DETAILED DESCRIPTION OF INVENTION

According to the present invention, a current collector having a reduced resistance grid may be utilized with a positive electrode or a negative electrode. Preferably, the current collector grid is used with a positive electrode. A hybrid energy storage device according to the present invention comprises at least one electrode having a reduced resistance grid according to the present invention.

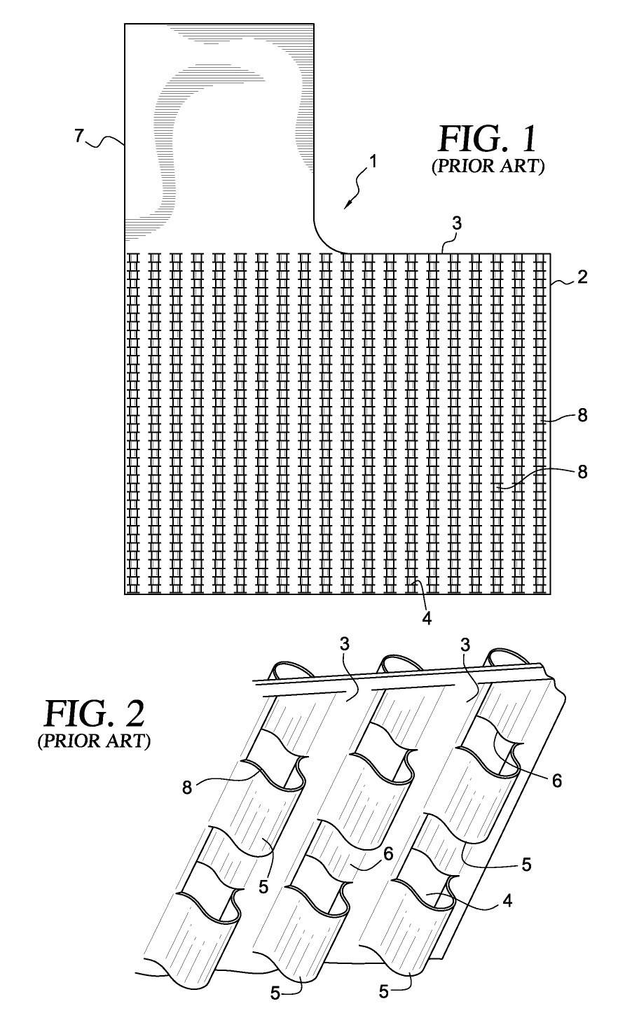

FIGS. 1-3 illustrate a prior art grid plate 1 of a current collector for an electrode. Generally, the plate 1 is characterized by a grid section 2 disposed below a tab 7 projecting above the upper edge of the plate where the plate incorporates a grid defined by a plurality of continuous, planar, spaced, parallel current channels 3 disposed between interleaved vertical rows 4 of raised and lowered segments 5 and 6.

Vertical rows 4 are established by punching, machining, or casting a planar sheet of conductive material, particularly metals, or molding the sheet directly which results in the creation of slots 8 directed orthogonally/perpendicularly relative to the tab 7 (FIG. 2). The slots permit both electrical and fluid communication between regions where active material or paste is placed behind raised portions 5 and behind lowered segments 6. The slots define the edges of the vertically directed channels established by the raised and lowered segments 5, 6 which are filled with conductive paste (e.g., lead oxides) to provide a current path from the lower portion of the plate to the upper portion and tab 7.

As schematically represented in FIG. 3, the current flow through plate 1 is continuous through the current channels 3 but interrupted between the slots 8 of the interleaved vertical rows 4. It is the presence of the discontinuity-forming slots 8 that provide a plurality of boundary conditions impacting the current flow through the plate to the tab. Over time these boundary conditions are susceptible to corrosion, particularly after repeated discharge and recharge cycles. Corrosion at the boundaries typically takes the form of spalling or flaking of the conductive paste as well as deterioration of the conductive plate. The increasing presence of corrosion at these boundaries results in increased resistance, ohmic loss, and a corresponding loss of power.

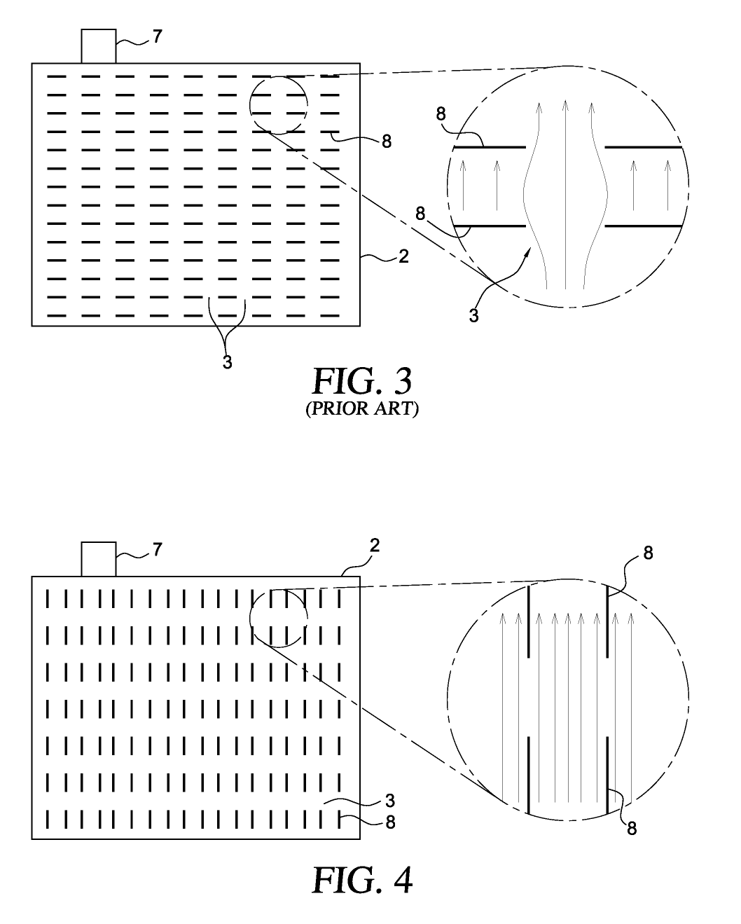

According to the present invention as schematically represented in FIG. 4, the rows of raised and lowered segments 5, 6 are reoriented to a horizontal configuration with respect to the tab. Thus, slots 8 lie in the direction of current flow instead of perpendicular to that flow. In this case, both the current channels 3 and the interleaved rows 4 are disposed horizontally relative to the grid plate's upper edge and the tab 7. In this way, the raised and lower segments of the plate provide substantially uninterrupted, undulating conductive ribbons extending the entire height of the profiled conductive plate. Only the width of the slots 8, rather than their entire length contribute to the establishment of boundary conditions according to the present invention.

The raised and lowered segments, and the slots, may have a variety of shapes including, but not limited to, an angled, square, or rounded configuration.

According to the present invention, the slots may be made as a result of punching, machining, or casting a planar sheet of conductive material, particularly metals, or molding the sheet. In embodiments, the slots may result from cutting the sheet or by deforming the planar sheet without cutting.

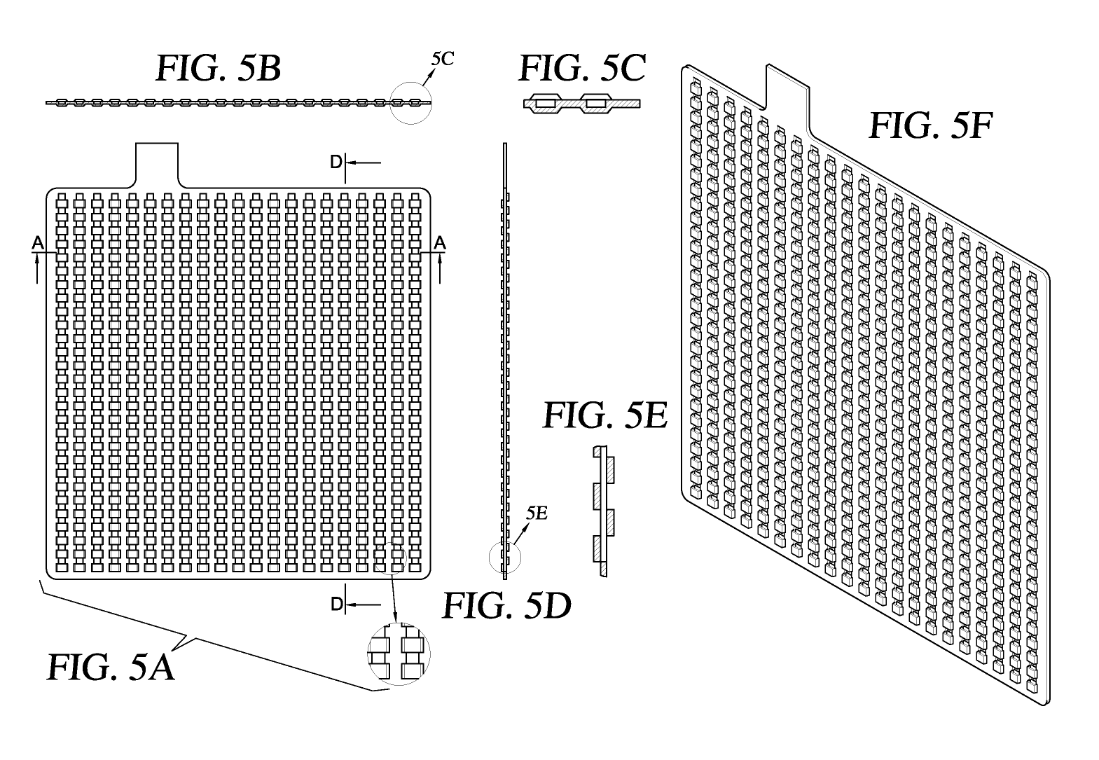

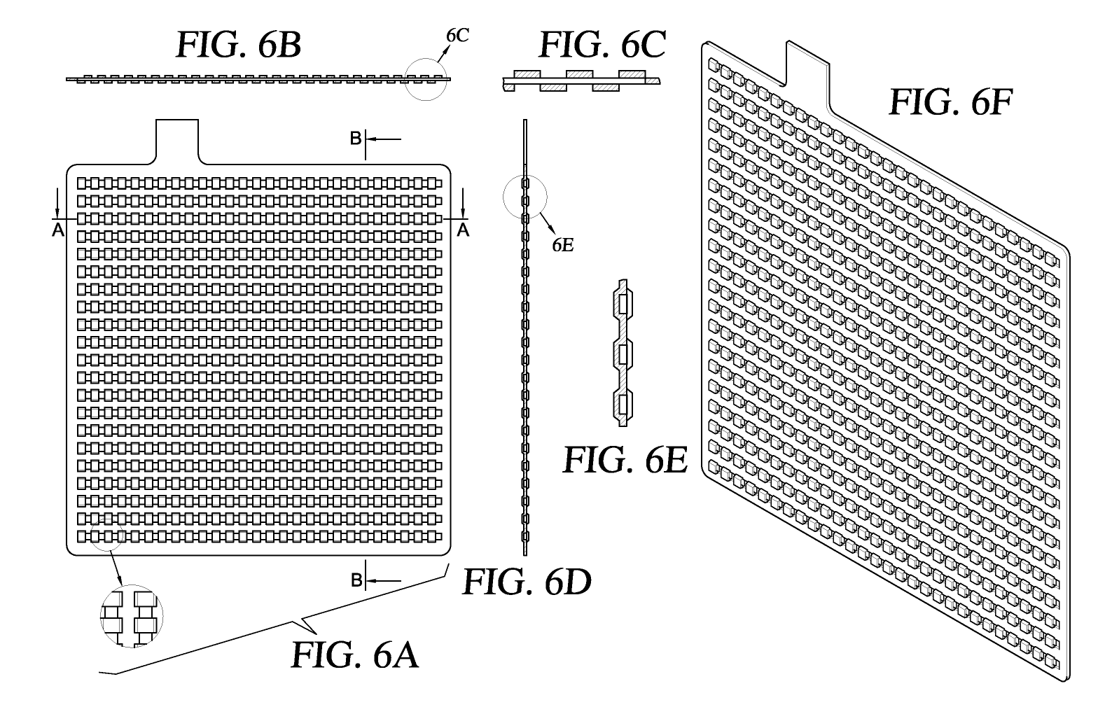

FIGS. 5A-5F illustrate a grid plate having angled slots with a vertical configuration. In contrast, FIGS. 6A-6F illustrate a grid plate according to the present invention having angled slots with a horizontal configuration.

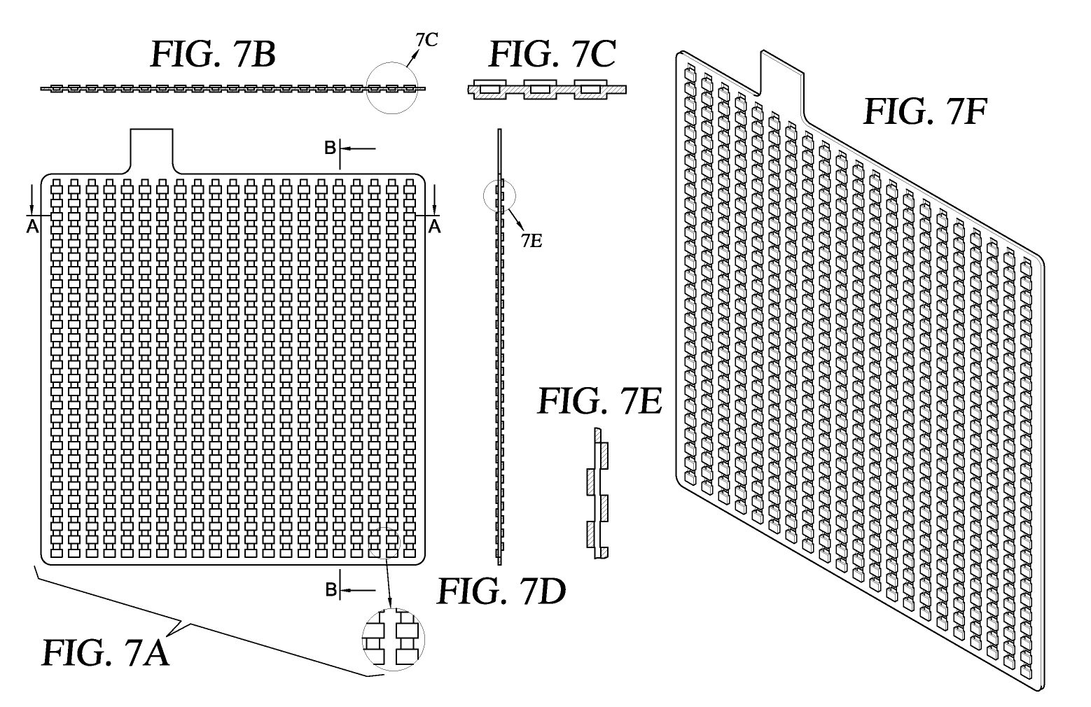

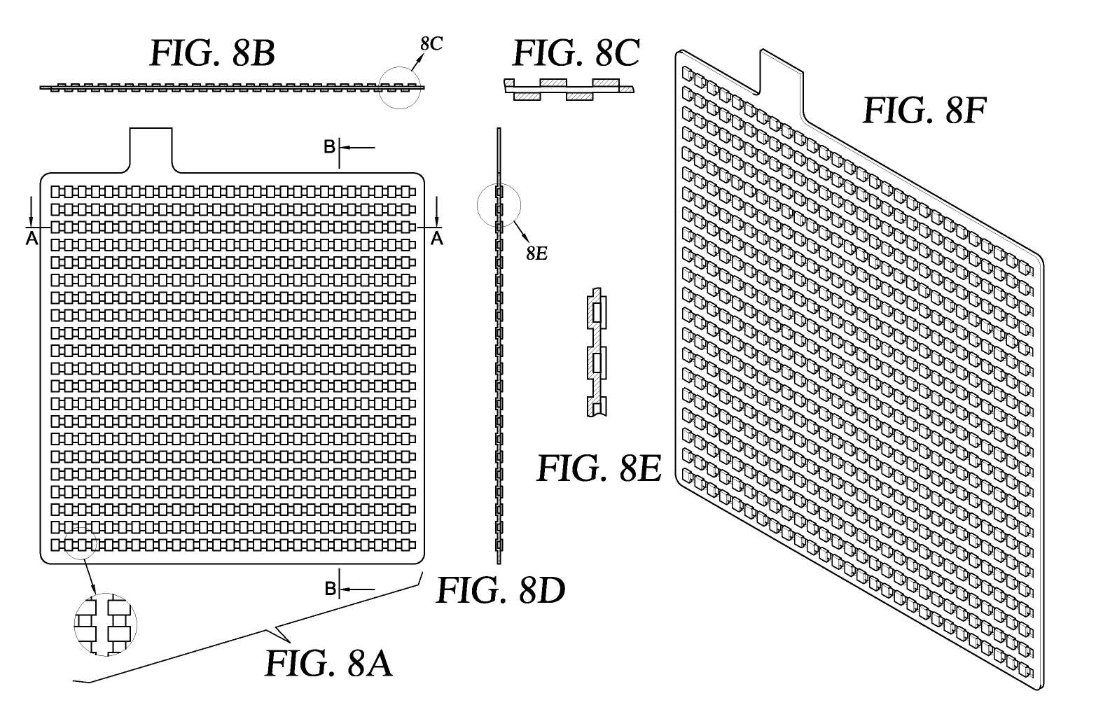

FIGS. 7A-7F illustrate a grid plate having vertically-oriented square slots. FIGS. 8A-8F illustrate a grid plate according to the present invention having horizontally-oriented square slots.

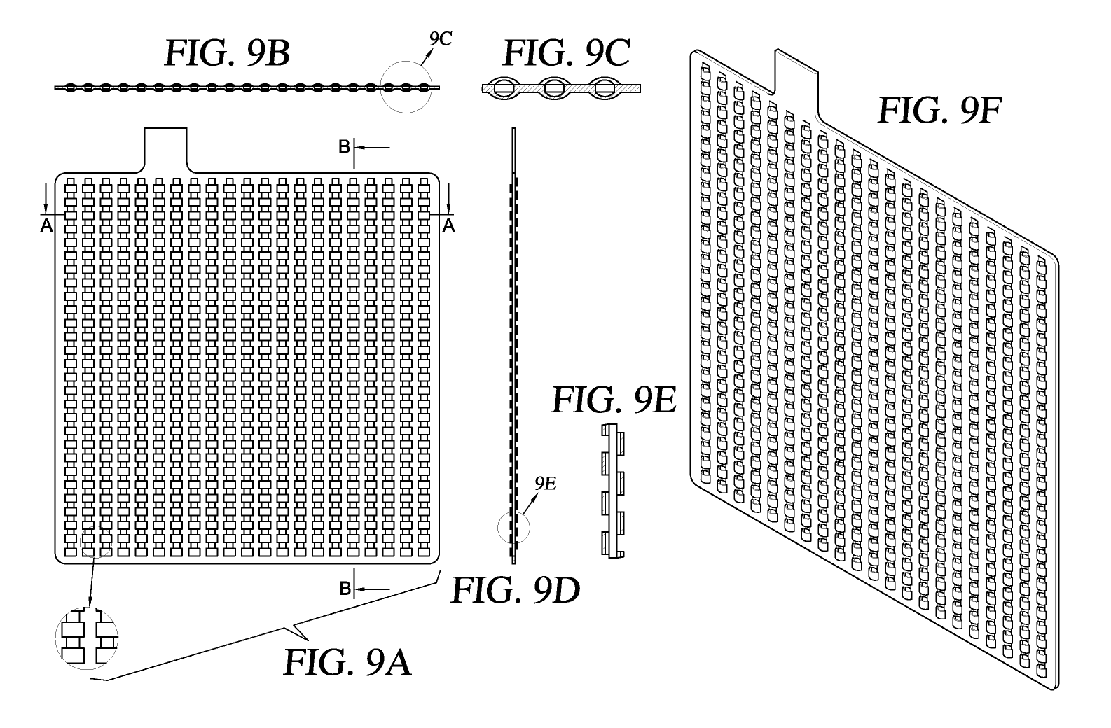

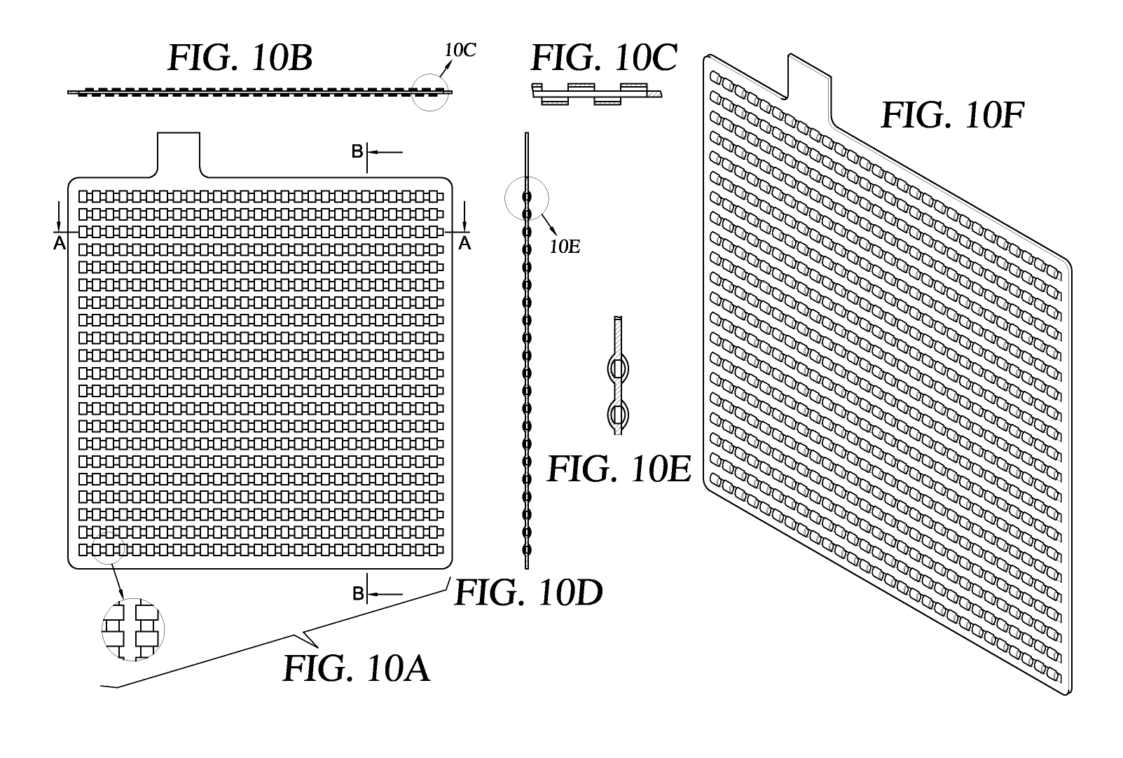

FIGS. 9A-9F illustrate a grid plate having rounded slots with a vertical configuration. FIGS. 1A-10F illustrate a grid plate according to the present invention having rounded slots with a horizontal orientation.

In other embodiments, the slots and channels of a grid plate may be oriented radially to direct current to the tab.

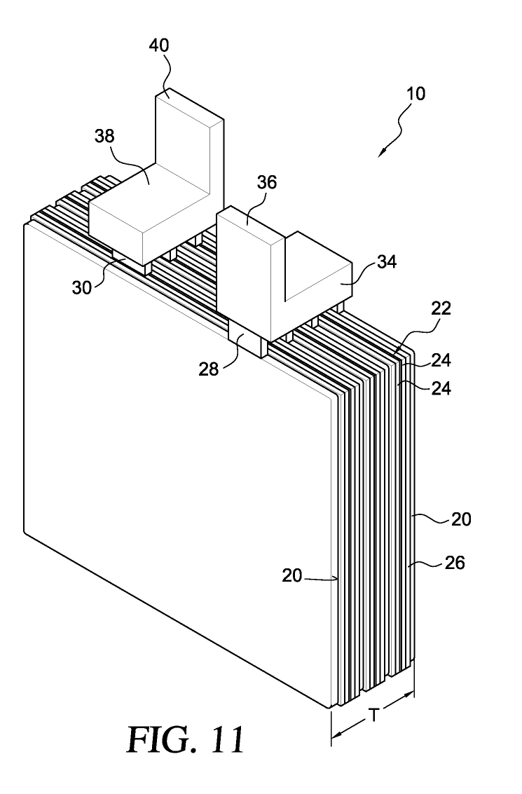

As illustrated in FIG. 11, a hybrid energy storage device 10 according to the present invention comprises at least one cell comprising at least one electrode having a reduced resistance grid structure. The current collector grid may be utilized with a positive electrode or a negative electrode. Preferably, the current collector grid is used with a positive electrode 20. The hybrid energy storage device comprises a separator 26 between at least one positive electrode 20 and at least one negative electrode. The hybrid energy storage device also comprises an electrolyte and a casing.

According to the present invention, a positive electrode of a hybrid energy storage device may comprise a current collector comprising lead or lead alloy; a lead dioxide paste adhered to and in electrical contact with the surfaces thereof; and a tab element 28 extending from a side, for example from a top edge, of the positive electrode. Positive electrode tab elements 28 may be electrically secured to one another by a cast-on strap 34, which may have a connector structure 36.

A negative electrode may comprise a conductive current collector 22; a corrosion-resistant coating; an activated carbon material 24; and a tab element 30 extending from a side, for example from above a top edge, of the negative electrode. Negative electrode tab elements 30 may be electrically secured to one another by a cast-on strap 38, which may have a connector structure 40.

Typically, the current collector of the negative electrode comprises a material having better conductivity than lead and may comprise copper, iron, titanium, silver, gold, aluminium, platinum, palladium, tin, zinc, cobalt, nickel, magnesium, molybdenum, stainless steel, mixtures thereof, alloys thereof, or combinations thereof.

A corrosion-resistant conductive coating may be applied to the current collector. The corrosion-resistant conductive coating is chemically resistant and electrochemically stable in the in the presence of an electrolyte, for example, an acid electrolyte such as sulfuric acid or any other electrolyte containing sulfur. Thus, ionic flow to or from the current collector is precluded, while electronic conductivity is permitted. The corrosion-resistant coating preferably comprises an impregnated graphite material. The graphite is impregnated with a substance to make the graphite sheet or foil acid-resistant. The substance may be a non-polymeric substance such as paraffin or furfural. Preferably, the graphite is impregnated with paraffin and rosin.

The active material of the negative electrode comprises activated carbon. Activated carbon refers to any predominantly carbon-based material that exhibits a surface area greater than about 100 m²/g, for example, about 100 m²/g to about 2500 m²/g , as measured using conventional single-point BET techniques (for example, using equipment by Micromeritics FlowSorb III 2305/2310). In certain embodiments, the active material may comprise activated carbon, lead, and conductive carbon. For example, the active material may comprise 5-95 wt. % activated carbon; 95-5 wt. % lead; and 5-20 wt. % conductive carbon.

The active material may be in the form of a sheet that is adhered to and in electrical contact with the corrosion-resistant conductive coating material. In order for the activated carbon to be adhered to and in electrical contact with the corrosion-resistant conductive coating, activated carbon particles may be mixed with a suitable binder substance such as PTFE or ultra high molecular weight polyethylene (e.g., having a molecular weight numbering in the millions, usually between about 2 and about 6 million). The binder material preferably does not exhibit thermoplastic properties or exhibits minimal thermoplastic properties.

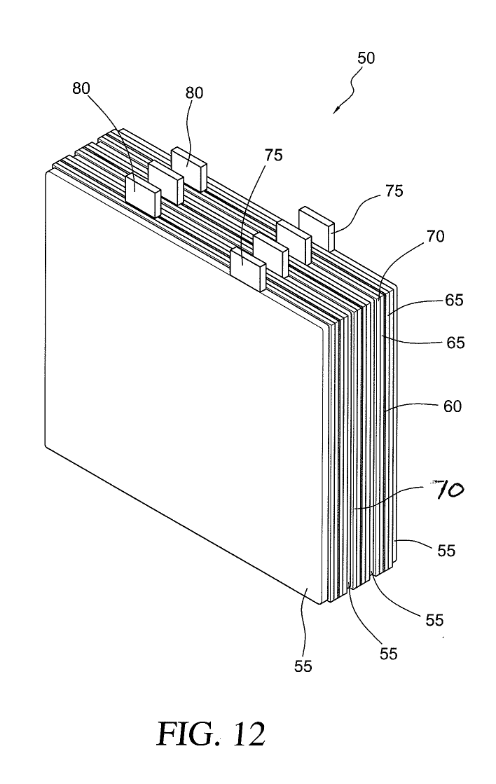

Referring to FIG. 12, there is shown an assembled cell in keeping with the present invention, designated generally at 50. This is a typical cell, and the specific details and dimensions of the cell are immaterial to the present discussion. It will be noted, however, that in this typical cell, there are four positive electrodes 55 which are lead-based, and typically the active material is lead dioxide. Also, in this typical cell, there are three negative electrodes, each of which comprises a highly conductive current collector 60 having porous carbon material 65 adhered to each face thereof.

It will also be noted that each typical cell 50 comprises a plurality of positive electrodes and a plurality of negative electrodes that are placed in alternating order. Between each adjacent pair of positive electrodes 55 and the active material 65 of the negative electrodes, there is placed a separator 70. In this typical construction as shown in FIG. 12, there are six separators 70.

Each of the positive electrodes 55 is constructed so as to have a tab 75 extending above the top edge of each respective electrode; and each of the negative electrodes 60, 65 has a tab 80 extending above the top edge of each of the respective negative electrodes.

Typically, the separators are made from a suitable separator material that is intended for use with an acid electrolyte, and that the separators may be made from a woven material such as a non-woven or felted material, or a combination thereof.

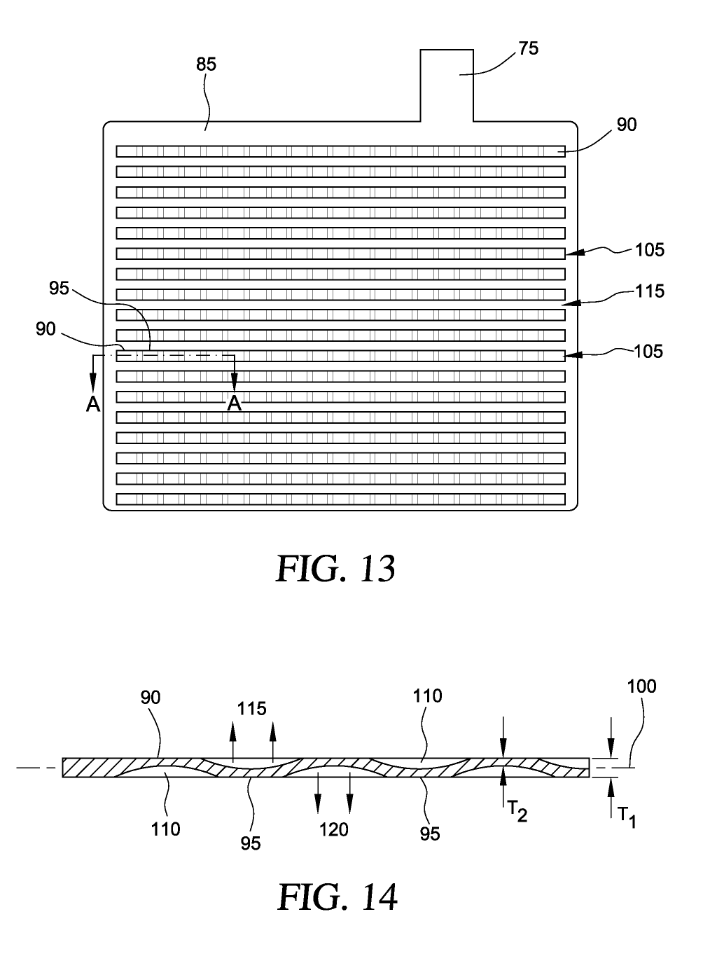

Turning now to FIG. 13, a lead current collector 85 for a positive electrode 55 is shown. Typically, the material of the current collector 85 is sheet lead, which may be cast or machined. The method of manufacture of the current collectors 85 is beyond the scope of the present invention.

Each current collector 85 has a plurality of raised portions 90, and another plurality of lowered portions 95, where the terms “raised” and “lowered” are taken with reference to a mean plane 100 for the current collector 85. The matrix of raised and lowered portions is such that they are arranged in rows 105, as can be seen in FIG. 13.

From FIG. 14, it will be seen that in cross-section the current collector 85 has an undulating appearance along each of the rows 105. On the reverse side of each of the lowered portions 95 there appears a significant bowl-like region into which active material 110 is placed. Likewise, on the reverse side of each of the raised portions 90, there also appears a significant bowl-like region into which active material 110 is placed.

It will be understood that slots will be formed in the regions between the raised and lowered portions in rows 105, and the intervening and undisturbed or planar portions shown in rows 115. The slots permit both electrical and fluid communication between regions where the active paste 110 is placed behind raised portions 90 and the regions where the active paste 110 is placed behind lowered portions 95. This also assists in reducing the likelihood of spalling or flaking of the active material during charge and discharge cycles.

During charging and discharging of the energy storage device being discussed herein, there will be expansion and contraction of the positive active material in the direction of arrows 115 and 120. However, it will be seen that such expansion and contraction, and in particular the expansion of the active material, will not affect the contact between the active material 110 and the current collector 85 to the extent it happens with grid current collectors commonly used in lead-acid batteries. Therefore, there is much less risk of the active material 110 shedding from the current collector 85, whereby decreased capacity will ensue, and may ultimately result in failure.

It will also be seen in FIG. 14 that the aggregate of thickness of the current collector 85, T₁, is greater than the thickness T₂ of the lead-based material from which the current collector 85 is manufactured.

Typically, a supercapacitor energy storage device comprises a plurality of cells 50, each of which is placed into a respective compartment in a compartmented casing (not shown).

According to the present invention, because shedding or flaking of the active material during charge and discharge cycles is significantly reduced, if not precluded, increased cycle life of a hybrid energy storage device may be achieved. Further, because boundary conditions are minimized in the direction of current flow to the tab, the impact of corrosion should be significantly reduced and the cycle life of the energy storage device should be substantially increased.

Another advantage which follows from the present invention is that less lead may be utilized when the current collectors are cast or machined. The undulating matrix will withstand compression forces of at least several psi which may be arise when respective cells into their respective compartments of a casing.

Although specific embodiments of the invention have been described herein, it is understood by those skilled in the art that many other modifications and embodiments of the invention will come to mind to which the invention pertains, having benefit of the teaching presented in the foregoing description and associated drawings.

It is therefore understood that the invention is not limited to the specific embodiments disclosed herein, and that many modifications and other embodiments of the invention are intended to be included within the scope of the invention. Moreover, although specific terms are employed herein, they are used only in generic and descriptive sense, and not for the purposes of limiting the description invention.

What is claimed is:

1. An energy storage device, comprising:
at least one positive electrode comprising:
a current collector comprising lead and having a plurality of raised and lowered portions with respect to a mean plane of the current collector and slots formed between the raised and lowered portions, wherein lead dioxide paste is adhered to and in electrical contact with the surfaces thereof; and
a tab portion; and
at least one negative electrode comprising a carbon material.

2. A hybrid supercapacitor energy storage device comprising:
at least one cell, wherein said at least one cell comprises a plurality of lead-based positive electrodes and a plurality of carbon-based negative electrodes;
wherein each carbon-based negative electrode comprises a highly conductive current collector, porous carbon material adhered to and in electrical contact with at least one surface of said current collector, and a tab element extending above the top edge of said negative electrode;
wherein each lead-based positive electrode has a current collector made of lead or lead alloy and active material having lead dioxide as main ingredient adhered to and in electrical contact with the surfaces thereof, and a tab element extending above the top edge of said positive electrode; and
wherein the front and back surfaces of said lead current collector each have a matrix of raised and lowered portions with respect to a mean plane for said lead current collector, and slots formed between the raised and lowered portions.
